(19) United States
(12) Patent Application Publication
(10) Pub. No.: US 2013/0163585 A1
(43) Pub. Date: Jun. 27, 2013

(54) TELEPHONE SYSTEM, SERVER APPARATUS, AND CONTROL METHOD USED IN THE SERVER APPARATUS

(71) Applicant: Shingo Kimura, Hachioji-shi (JP)

(72) Inventor: Shingo Kimura, Hachioji-shi (JP)

(21) Appl. No.: 13/606,450

(22) Filed: Sep. 7, 2012

(30) Foreign Application Priority Data
Dec. 27, 2011 (JP) 2011-285835

(51) Int. Cl. H04L 12/66; H04M 11/04

(52) U.S. Cl. 370/352

(57) ABSTRACT

According to one embodiment, a server apparatus includes a memory, a determination module, a storage controller and a service controller. The memory stores in an authentication management table associating identification information with first authentication information and second authentication information. The determination module determines whether registration is authenticated based on the authentication management table. The storage controller stores the identification information, the attribute information, and the IP addresses in a registration management table. The service controller performs control regarding use of the communication services.

### CROSS-REFERENCE TO RELATED APPLICATIONS

This application is based upon and claims the benefit of priority from Japanese Patent Application No. 2011-285835, filed Dec. 27, 2011, the entire contents of which are incorporated herein by reference.

### FIELD

Embodiments described herein relate generally to a telephone system, such as an Internet Protocol (IP) telephone system, a server apparatus, and a control method used in the server apparatus.

### BACKGROUND

Recently, an IP telephone system which transmits and receives an image and sound bi-directionally as packet data in real time via an IP network has become pervasive. In the IP telephone system, not only can an extension-to-extension communication and an outside call be made by each server apparatus connected to the IP network, but also extension communication and outside call between server apparatuses via the IP network can be made.

Meanwhile, in the above-mentioned system, it may become necessary to add an IP telephone terminal due to a personnel increase or change in the business affairs, etc., in the department which has the server apparatus, or remove an unnecessary IP telephone terminal. In such cases, the frequency of setting extension numbers in each server apparatus will increase, which is extremely undesired.

Hence, in the IP telephone system described above, a shared extension number is set among a plurality of extension terminals.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic structure diagram of a Voice over Internet Protocol (VoIP) system according to a first embodiment;

FIG. 2 is a function block diagram showing an example of a call control server shown in FIG. 1;

FIG. 3 is a diagram showing an example of an extension data management table;

FIG. 4 is a diagram showing an example of registration data management table;

FIG. 5 is a diagram showing an example of function setting table;

FIG. 6 is a diagram showing an example of a position information management table;

FIG. 7 is a block diagram showing a program structure of an extension data generation module shown in FIG. 2;

FIG. 8 is a block diagram showing a program structure of a registration processing module shown in FIG. 2;

FIG. 9 is a block diagram showing a program structure of an outgoing call processing module shown in FIG. 2;

FIG. 10 is flowchart showing a control procedure of the call control server in logging in by an extension number which an IP telephone terminal according to the first embodiment uses subsidiary;

FIG. 11 is a sequence diagram showing a communication operation among the IP telephone terminal, the call control server, and a carrier exchange server, when outgoing call control of an emergency call is performed in the first embodiment;

FIG. 12 is a sequence diagram showing a call transfer operation made for a primary user of an extension number as a second embodiment;

FIG. 13 is a diagram showing an example of call transfer destination data in the second embodiment; and

FIG. 14 is a sequence diagram showing the call transfer operation made for a secondary user of the extension number in the second embodiment.

### DETAILED DESCRIPTION

Various embodiments will be described hereinafter with reference to the accompanying drawings. In general, according to one embodiment, a telephone system includes a plurality of telephone terminals and a server apparatus. The server apparatus registers the plurality of telephone terminals. The server apparatus includes a memory, a determination module, a storage controller and a service controller. The memory stores in an authentication management table associating identification information with first authentication information and second authentication information, wherein the identification information is information to use a plurality of communication services relating to exchange processing among the plurality of telephone terminals, wherein the first authentication information allows use of the plurality of communication services, and wherein the second authentication information is subsidiary to the first authentication information and allows use of at least a part of the plurality of communication services. The determination module refers to the authentication management table based on the identification information and the authentication information included in a registration request, and determine whether registration is authenticated based on the reference result, when the registration request including the identification information and authentication information is received from one of the telephone terminals. The storage controller associates the identification information with attribute information indicating the first authentication information/second authentication information used in the authentication, and the IP addresses, and stores the identification information, the attribute information, and the IP addresses in a registration management table based on the determination result by the determination module. The service controller performs control regarding use of the communication services by the telephone terminals registered based on the registration management table.

### First Embodiment

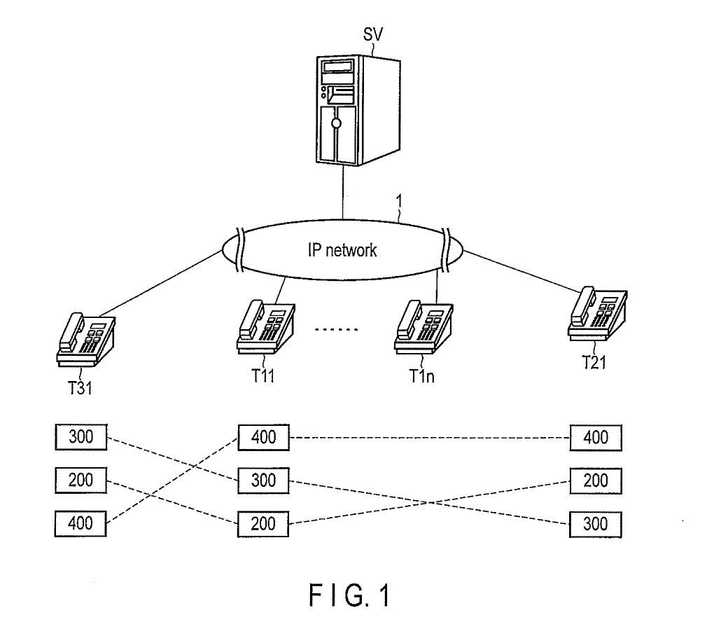

FIG. 1 is a schematic structure diagram of a Voice over Internet Protocol (VoIP) system according to a first embodiment.

In this VoIP system, it is assumed that IP telephone terminals T11 to T1n are installed in area A, IP telephone terminal T21 is installed in area B, and IP telephone terminal T31 is installed in area C. Further, it is assumed that a call control server SV is installed in area A. IP telephone terminals T11 to T1n, T21, and T31 are registered in the call control server SV via an IP network 1.

IP telephone terminals T11 to T1n, T21, and T31 are terminals provided with a communication processing function and a media information processing function. The call control server SV is provided with an exchange control function which establishes a session in accordance with a session initiation protocol (SIP), for example, among IP telephone terminals T11 to T1n, T21, and T31. Further, after the session is established, by transmitting and receiving an IP packet by peer-to-peer connection between the IP telephone terminal at the calling side and the IP telephone terminal at the receiving side, voice communication is performed.

Further, to IP telephone terminals T11, T21, and T31, shared extension numbers “200”, “300”, and “400” can be assigned. The shared extension number “200” is used by a primary user in IP telephone terminal T11, the shared extension number “300” is used by a primary user in IP telephone terminal T21, and the shared extension number “400” is used by a primary user in IP telephone terminal T31.

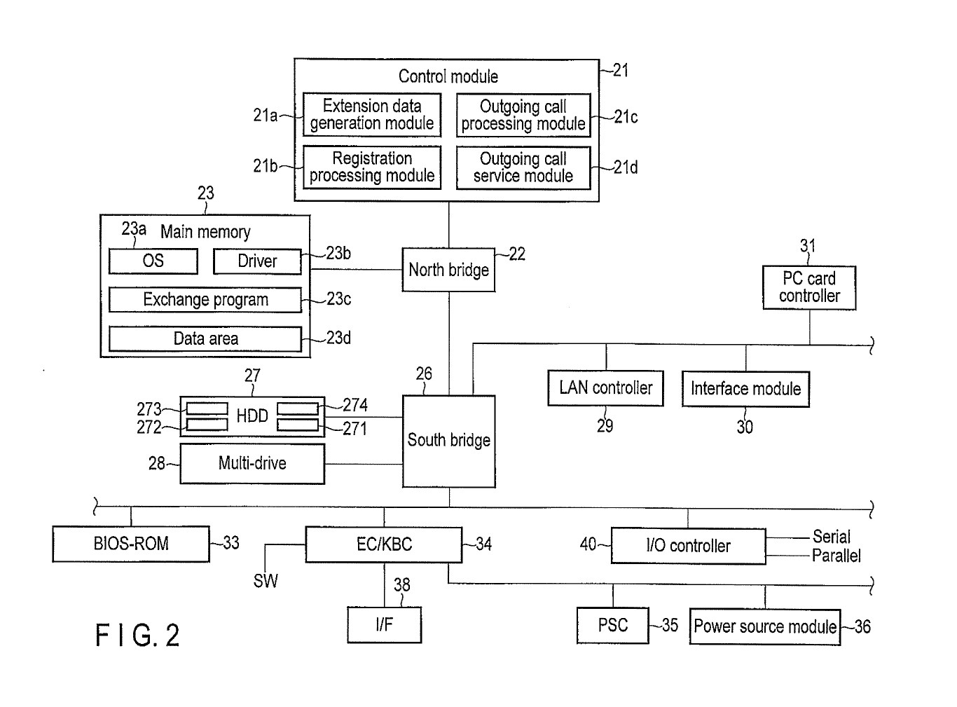

FIG. 2 is a functional block diagram showing an example of the call control server SV shown in FIG. 1. The call control server SV comprises a control module 21, a north bridge 22, a main memory 23, a south bridge 26, a hard disk drive (HDD) 27, a multi-drive 28, a LAN controller 29, an interface module 30, a PC card controller 31, a basic input/output system ROM (BIOS-ROM) 33, an embedded controller/keyboard controller (EC/KBC) 34, a power source controller (PSC) 35, a power source module 36, an interface 38, and an I/O controller 40.

The main body of the control module 21 is a central processing unit (CPU), and the control module 21 is configured to control the whole of the call control server SV. The control module 21 uses the main memory 23 as a work area, and executes an operating system (OS) 23a, a driver 23b, and an exchange program 23c, etc., which are loaded into the main memory 23 from the HDD 27.

The north bridge 22 comprises various controllers which perform bridge processing between the control module 21 and the south bridge 26, and control of the main memory 23.

The south bridge 26 is connected to the north bridge 22 via a hub link, and comprises various controllers which control various devices (EC/KBC34, I/O controller, etc.) on a Low Pin Count (LPC) bus, various PCI devices (LAN controller 29, interface module 30, PC card controller 31, etc.) on a Peripheral Component Interconnect (PCI) bus, a disk drive compatible with Integrated Drive Electronics (IDE), and USB devices.

The HDD 27 is connected to the south bridge 26 as the device compatible with primary IDE, and is the embedded hard disk which stores various programs, such as the OS and exchange program, and various kinds of data 23d. The multi-drive 28 is connected to the south bridge 26 as the device compatible with secondary IDE, and drives a CD-ROM, a DVD-ROM, and a CD-R/RW, which are removable recording media.

The LAN controller 29 is connected to the south bridge 26 as the PCI device, comprises a communication function which complies with the specification of a wired LAN, and performs communication with a communication device having the same communication function.

The interface module 30 is connected to the south bride 26 as the PCI device, comprises a communication function which comprises the specification of the IP network 1, and performs processing relating to transfer of an IP packet.

The PC card controller 31 is connected to the south bridge 26 as the PCI device, complies with the specification of the Personal Computer Memory Card International Association (PCMCIA), and controls various PC cards. The BIOS-ROM 33 is connected to the LPC bus, and stores a basic input/output system (BIOS) which performs setting processing mainly for hardware inside the call control server SV when the power is turned on. The EC/KBC 34 is connected to the LPC bus, and controls the power source controller 35. The EC/KBC 34 is formed by integrating an embedded controller EC and a keyboard controller.

The power source controller 35 is connected to the EC/KBC 34 via an I2C bus, and controls a voltage to be supplied to each part within the call control server SV. The power source module 36 generates drive power and supplies the drive power to each part in the call control server SV. An input device, etc., can be connected by the interface 38, which performs communication of signals between the interface 38 and the EC/KBC 34. The I/O controller 40 is connected to the LPC bus, and performs input/output control of a serial signal and a parallel signal transmitted externally.

In the call control server SV, under the control of the control module 21, the exchange program 23c developed on the main memory 23 realizes a predetermined exchange processing function in cooperation with the LAN controller 29. The call control server SV realizes the exchange function between the telephone terminals by loading the exchange program 23c into a general computer server, and executing this program. As in a general computer, the call control server SV adopts a virtual memory system in which an area where data is stored is deemed to be continuous in the software (such as a process) even if such memory area is physically discontinuous.

Incidentally, the HDD 27 is provided with an extension data management table 271, a registration data management table 272, a function setting table 273, and a position information management table 274.

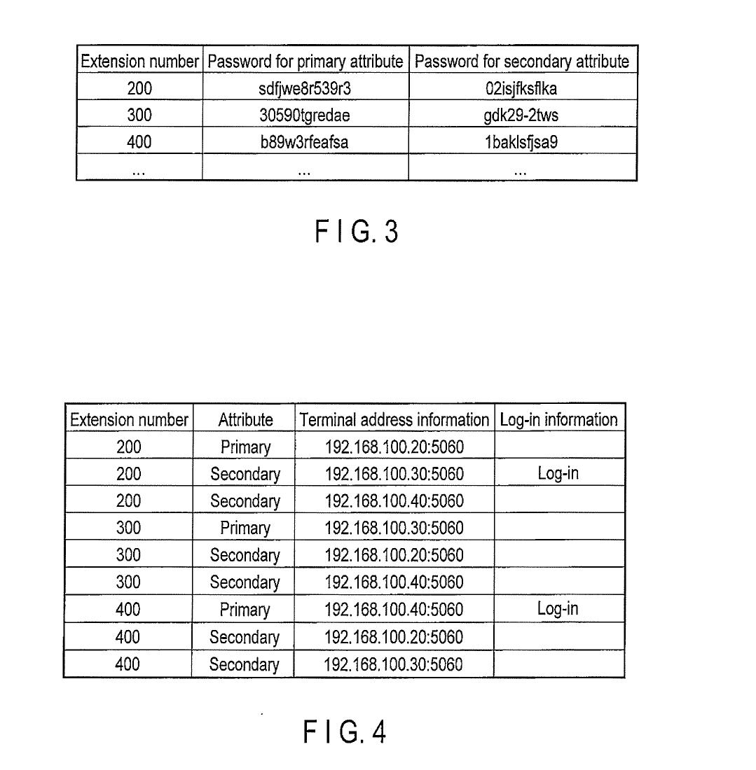

The extension data management table 271 is a table which manages a password to be assigned to each extension number. As shown in FIG. 3, the extension data management table 271 stores data which represents relations among the extension number, a password for primary attribute, and a password for secondary attribute.

The registration data management table 272 is a table for managing the registration states of each of IP telephone terminals T11 to T1n, T21, and T31. As shown in FIG. 4, the registration data management table 272 can dynamically store data which represents relations among the extension number a user wishes to use, attribute information indicating whether the user is a primary user or a secondary user, terminal address information such as the IP address, and log-in information indicating whether the user has logged in or not. Here, it is assumed that IP telephone terminal T11 has IP address 192.168.100.20, IP telephone terminal T21 has IP address 192.168.100.30, and IP telephone terminal T31 has IP address 192.168.100.40. In IP telephone terminal T11, extension number 200 is authenticated and registered as the extension number with primary attribute, and persons who use extension numbers 300 and 400 are authenticated and registered as secondary users. The authentication and registration are carried out in the same way in IP telephone terminals T21 and T31.

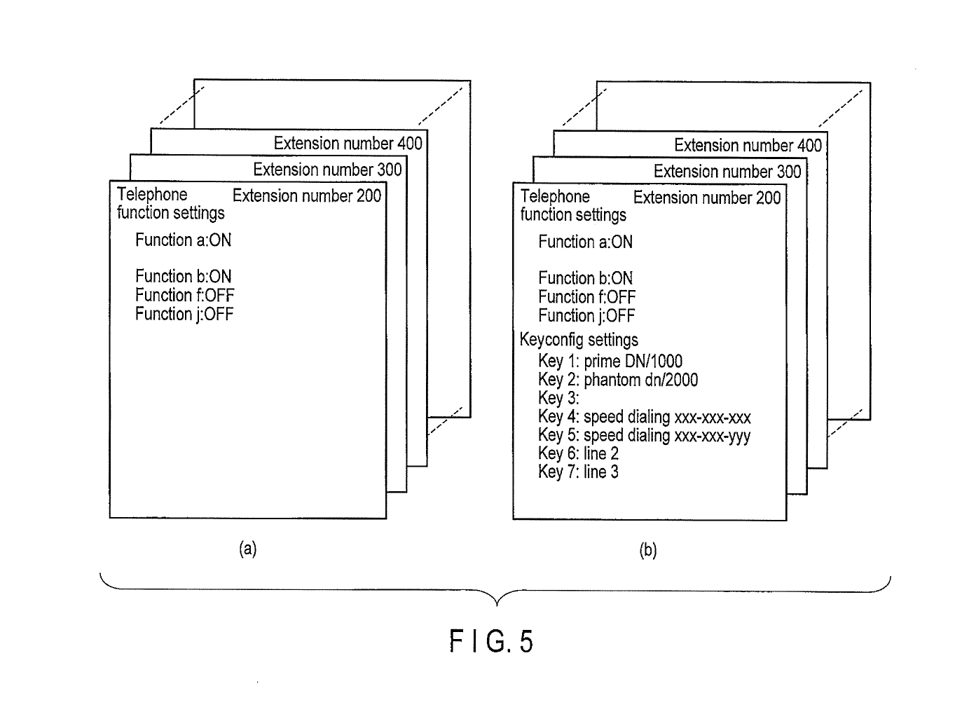

As shown in FIG. 5(a), the function setting table 273 is a table which shows available functions for each extension number, and includes telephone function settings, for example. In the telephone function settings, on/off is set for each function, and in keyconfig settings, the use for each key is set. That is, when the extension number 200 that is the primary number of IP telephone terminal T11 is used at the IP telephone terminal T11, function a (for example, call blocking), function b (for example, call transfer), function f (for example, voice mail function), and function j (for example, auto attendant function) can be used. Further, as shown in FIG. 5(b), the function setting table 273 may include keyconfig settings. Speed dialing for an outside call is assigned to keys 4 and 5, “capturing of line 2” is assigned to key 6, and “capturing of line 3” is assigned to key 7. These functions and keys can be set by the primary user of IP telephone terminal T11.

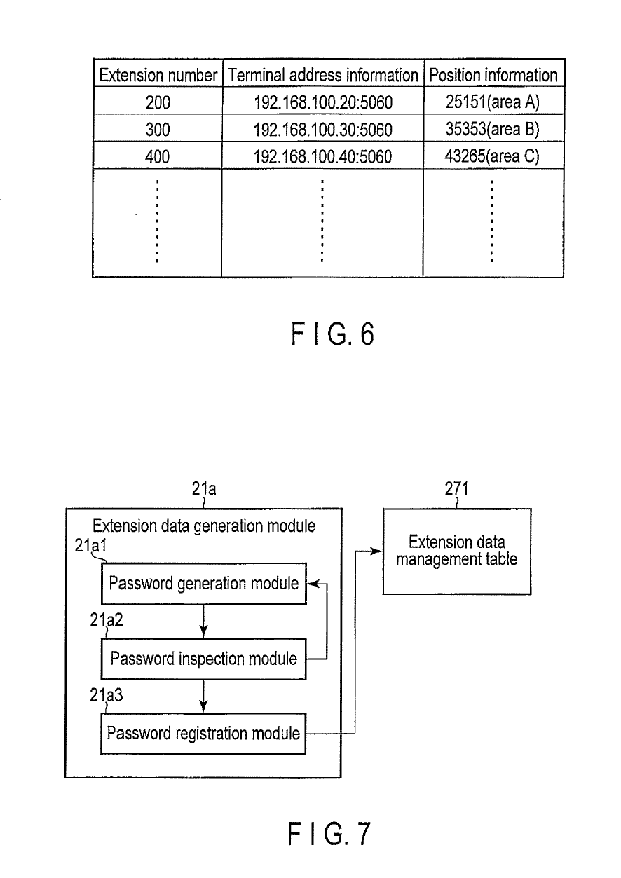

The position information management table 274 is a table for managing position information on each of IP telephone terminals T11 to T1n, T21, and T31. As shown in FIG. 6, the position information management table 274 stores data representing relations among the extension number, terminal address information of IP telephone terminal associated with the extension number with primary attribute, and an identifier corresponding to the position information.

The control module 21 comprises an extension data generation module 21a, a registration processing module 21b comprising a determination module and a storage controller, an outgoing call processing module 21c comprising a service controller, and an outgoing call service module 21d.

FIG. 7 is a block diagram showing a program structure of the extension data generation module 21a. The extension data generation module 21a comprises a password generation module 21a1, a password inspection module 21a2, and a password registration module 21a3. When a new extension number is generated in the system, the password generation module 21a1 generates passwords for the primary user and the secondary user. Random numbers, etc., are used in generating the passwords so that the two passwords show no relevance to each other. Then, the password inspection module 21a2 inspects whether the generated passwords are unique in the system. When the same password already exists, the password generation module 21a1 regenerates the password. A set of passwords which have been assured to be unique in the system is sent to the extension data management table 271 via the password registration module 21a3, and registered in the extension data management table 271.

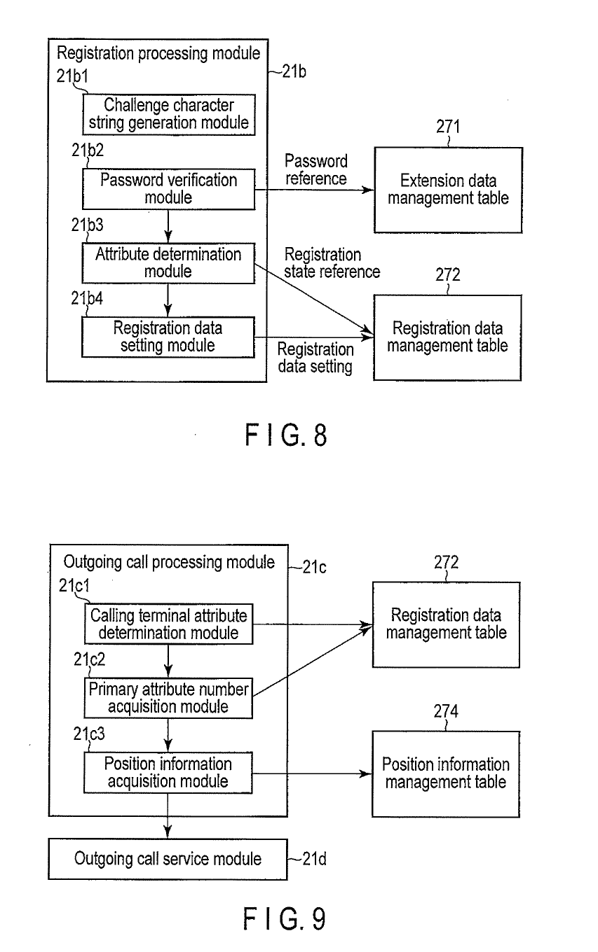

FIG. 8 is a block diagram showing a program structure of the registration processing module 21b. Here, digest authentication which is in wide use will be described as an example of authentication algorithm.

The registration processing module 21b comprises a challenge character string generation module 21b1, a password verification module 21b2, an attribute determination module 21b3, and a registration data setting module 21b4.

First of all, the challenge character string generation module 21b1 generates an arbitrary character string, and sends it back to the IP telephone terminal. IP telephone terminals T11, T21, and T31 use the password set for each extension number and the received challenge character string to calculate a one-way hash value in accordance with the determined algorithm, and notify the call control server SV again of the calculation result. The password verification module 21b2 verifies whether the hash value calculated in the same way agrees with the received hash value. In doing so, the password verification module 21b2 acquires passwords for both primary and secondary users which are associated with the extension number subjected to authentication from the extension data management table 271, and calculates the hash value individually using the passwords of the two. Here, Hp represents the hash value calculated from the password of the primary user, Hs represents the hash value calculated from the password of the secondary user, and Hr represents the hash value received from IP telephone terminals T11, T21, and T31.

These three hash values are sent to the attribute determination module 21b3. The attribute determination module 21b3 determines that registration is made from the terminal which primarily uses the extension number in question if Hp and Hr agree with each other, and that registration is made from the secondarily used terminal if Hs and Hr agrees with each other. If no agreement can be found, the attribute determination module 21b3 determines that authentication failed, and sends registration rejection to IP telephone terminals T11, T21, and T31.

Further, the attribute determination module 21b3 refers to the registration data management table 272 whether registration is already made by the primary user on the extension number in question. If registration by the primary user is already made, even if the received hash value Hr agrees with Hp, registration rejection is sent.

Lastly, the registration data setting module 21b4 groups together the extension number, registration attribute, terminal address information, and log-in information, and registers those kinds of data in the registration data management table 272.

FIG. 9 is a block diagram showing a program structure of the outgoing call processing module 21c. The outgoing call processing module 21c comprises a calling terminal attribute determination module 21c1, a primary attribute number acquisition module 21c2, and a position information acquisition module 21c3.

The calling terminal attribute determination module 21c1 extracts the extension number of the caller and the address information regarding the calling terminal from the calling signal, and refers to the registration data management table 272 for the attribute of the calling terminal based on the extracted extension number and address information. For example, when IP telephone terminal T21 makes an emergency call using the key available for extension number 200, the calling terminal attribute determination module 21c1 receives the information 200 as the extension number, and 192.168.100.30:5060 as the terminal address.

Incidentally, as a result, the attribute is understood as secondary from the above combination. When the result shows that the attribute is secondary, the primary attribute number acquisition module 21c2 makes an inquiry to the registration data management table 272 for the extension number having the primary attribute associated with the terminal address which is the same as that of the calling terminal.

Here, the number 300 can be obtained as the extension number of IP telephone terminal with the primary attribute having the terminal address 192.168.100.30.5060. The position information acquisition module 21c3 acquires position information associated with primary number 300 of the calling terminal obtained as stated above from the position information management table 274, and adds an identifier corresponding to the position information to the calling signal sent to the network side via the outgoing call service module.

Next, an operation of the VoIP system according to the above structure will now be described.

(Log-In Operation)

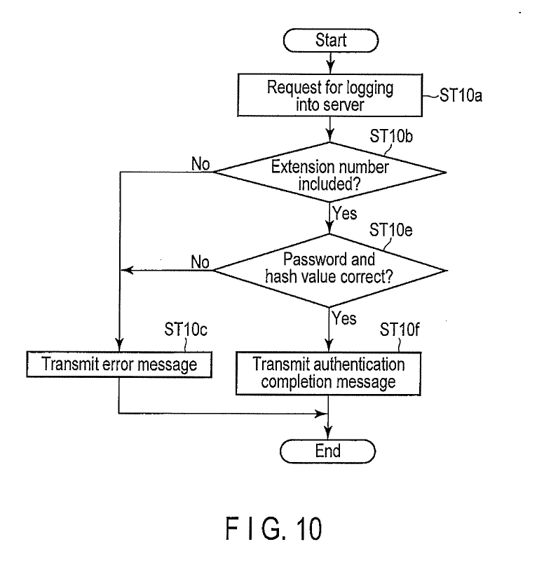

FIG. 10 is a flowchart showing a control procedure of the call control server SV in logging in by extension number 200 which IP telephone terminal T21, for example, uses subsidiary.

On startup, when extension number 200 is used, a user of IP telephone terminal T21, for example, accesses the call control server SV. When access is made, the call control server SV generates an arbitrary character string in the registration processing module 21b, and sends it back to IP telephone terminal T21.

Then, the user of IP telephone terminal T21 enters “200” which is the extension number that the user wants to use, and the password “02isjfksflka”, and attempts logging into the call control server SV. When the above entry is finished, a hash value is calculated by using the character string received from the call control server SV and the password, and the extension number, the hash value, and the IP address are included in a log-in request (for example, RESISTER in SIP), which is sent to the call control server SV.

The call control server SV, which received the log-in request (RESISTER) from IP telephone terminal T21, shifts the state to block ST10b from block ST10a. Extension number 200 will be checked here whether this number agrees with a group of extension numbers previously registered in the extension data management table 271. If the extension number is not registered, log-in is not permitted, and the block shifts the state to block ST10c from block ST10b, and returns an error message (for example, ACK) to IP telephone terminal T21 that the extension number does not exist in the extension data management table 271.

If the check has been passed for extension number 200, the call control server SV shifts the state to block ST10e from block ST10b to authenticate the password by comparing hash value Hs and hash value Hr.

If the password or the hash value is not correct, the call control server SV shifts the state to block ST10e from block ST10c, and returns an error message (ACK) indicating the above to IP telephone terminal T21.

On the other hand, if all checks have been passed, the call control server SV shifts the state to block ST10f from block ST10e to return a message of authentication completion to IP telephone terminal T21. The call control server SV registers that user as the logging-in user in the registration data management table 272.

(Emergency Call Service)

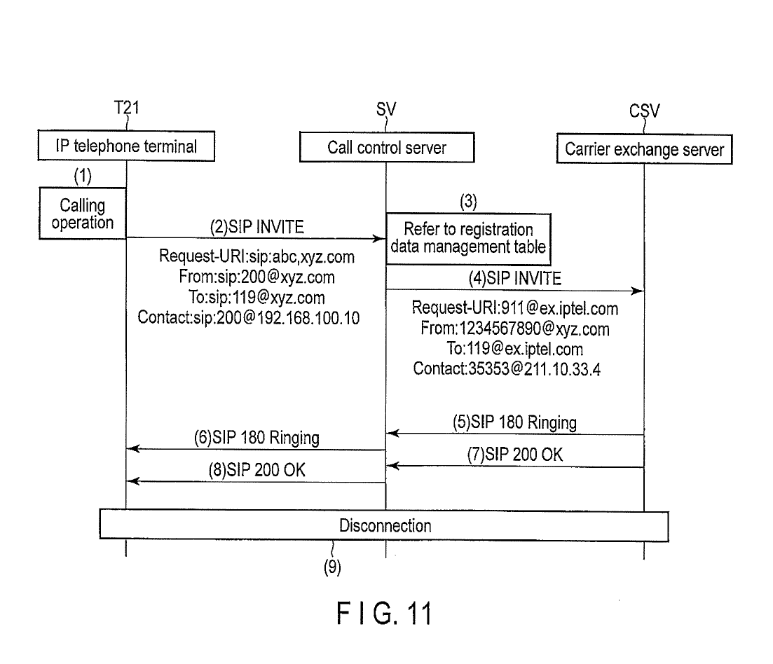

FIG. 11 is a sequence diagram showing a communication operation among IP telephone terminal T21, the call control server SV, and a carrier exchange server CSV, when outgoing call control of an emergency call is performed.

Given that a user in area B dials “119” by pressing line key assigned for extension number 200, for example, for making an emergency call from IP telephone terminal T21 ((1) of FIG. 11), IP telephone terminal T21 transmits a call request (INVITE message) to the call control server SV ((2) of FIG. 11).

When the call request is received, the call control server SV specifies area A, which is where extension number 200 is generally used in IP telephone terminal T11 by a primary user. In this case, calling will be made to the emergency call destination of area A which is distant from area B.

Hence, in the first embodiment of the present system, the call control server SV refers to the registration data management table 272 based on the IP address of the calling source included in the call request, and specifies that the primary extension number of the calling terminal is “300” ((3) of FIG. 11). Further, the call control server SV reads emergency call area code “35353” corresponding to extension number 300 from the position information management table 274, and transmits the INVITE message on which the emergency call area code “35353” is superimposed to the carrier exchange server CSV through the IP network 1 ((4) of FIG. 11).

The carrier exchange server CSV specifies the position information regarding the caller as “area B”, based on the emergency call area code included in the INVITE message, and transfers the INVITE message to an emergency call reception end within area B, for example. At the same time, the carrier exchange server CSV returns “180 Ringing” indicating that incoming call notification is made to the call control server SV ((5) of FIG. 11). This incoming call notification is made by a sound or a display.

The call control server SV transmits “180 Ringing” to IP telephone terminal T21, which is the calling source, and notifies that the incoming call notification is made to the emergency call destination ((6) of FIG. 11).

When the emergency call reception end respond to the incoming call notification, the carrier exchange server CSV transmits a response message (200 OK) to the call control server SV ((7) of FIG. 11).

The call control server SV transmits “200 OK” to IP telephone terminal T21 ((8) of FIG. 11). As described above, a communication link by peer-to-peer connection, for example, is formed between IP telephone terminal T21, which is the calling source, and the emergency call reception end within area B, and after that, RTP packets are transferred to allow a telephone conversation ((9) of FIG. 11).

As described above, in the first embodiment, in the call control server SV, the extension data management table 271 in which the password for primary attribute and the password for secondary attribute assigned for users of IP telephone terminals T11, T21, and T31 that use the shared extension number “200” are associated with each of extension numbers “200”, “300”, and “400” is stored in the HDD 27. For example, when a register request is received from IP telephone terminal, it is possible to determine whether the user of IP telephone terminal T21 that made the register request is a primary user or a secondary user by using the extension data management table 271. Together with this determination result, the extension number requested to be registered and the IP address of IP telephone terminal T21 are stored in the registration data management table 272, so that the most suitable communication service can be utilized depending on the user who uses extension number “200”.

Accordingly, when a single extension number “200” is shared, there is no need to provide a special function in IP telephone terminals T11, T21, and T31. It is possible to restrict the communication service to be used depending on the user of each of IP telephone terminals T11, T21, and T31 at low cost, and it is also possible to clarify the accounting processing, etc., for each user by the restriction.

In addition, by performing failure monitoring on the basis of the extension numbers having primary attributes, it is possible to reduce traffic in the failure monitoring.

Also, according to the first embodiment, in the call control server SV, the position information management table 274 in which the IP address of each of IP telephone terminals T11 to T1n, T21, and T31 is associated with position information indicating the connecting locations of IP telephone terminals T11 to T1n, T21, and T31 in the IP network 1 is stored in the HDD 27. By doing so, when an emergency call is made from IP telephone terminal T21 which has been registered by using the password for secondary attribute with respect to extension number “200”, the position information regarding IP telephone terminal T21 in question is read from the position information management table 274 so that the emergency call request including the position information can be transmitted to the emergency call reception end.

Accordingly, an emergency call can be efficiently made to the emergency call reception end in area B, which is closest to the position of IP telephone terminal T21 in which extension number 200 is used by the secondary user, without selecting the emergency call reception end in area A which is closest to IP telephone terminal T11 in which extension number 200 is primarily used by the primary user.

Further, according to the first embodiment, if shared extension number “200” is already registered from IP telephone terminal T11 by the primary user, the other IP telephone terminals T21 and T31 can be prevented from being registered to extension number “200”.

### Second Embodiment

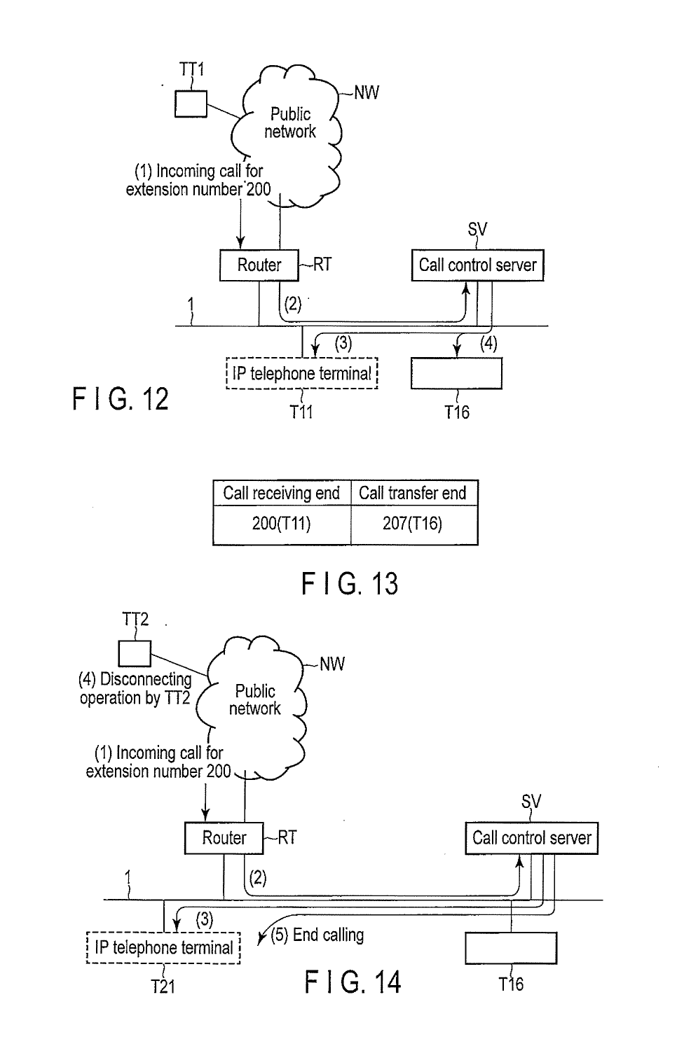

FIG. 12 is a sequence diagram showing a call transfer operation made for extension number 200 that is the primary number of IP telephone terminal T11 as a second embodiment.

As is shown in FIG. 12, given that a call which specifies extension number 200 as the number of a call receiving end is made by an external terminal TT1, and an incoming call signal including extension number 200 reaches a router RT from a public network NW accordingly ((1) of FIG. 12), the router RT transfers the incoming call signal to the call control server SV via the IP network 1 ((2) of FIG. 12).

The call control server SV extracts the incoming call number from the incoming call signal notified by the router RT, and determines the call receiving end corresponding to the incoming call number 200 based on the registration data management table 272.

Here, in a case where IP telephone terminal T11 has logged in for extension number 200, the call control server SV makes an incoming call notification by transmitting the incoming call signal to IP telephone terminal T11 ((3) of FIG. 12).

However, if IP telephone terminal T11 does not respond within predetermined time, the call control server SV refers to the function setting table 273 corresponding to extension number 200. The call control server SV determines whether a call transfer function, namely, “function b” is enabled, and when this function is enabled, the call control server SV determines whether a call transfer end is registered in a call transfer end data table 275 provided in the HDD 27. As shown in FIG. 13, for example, when the call transfer end is registered, the call control server SV transmits the incoming call signal to IP telephone terminal T16 at the call transfer end to give the incoming call notification ((4) of FIG. 12).

FIG. 14 is a sequence diagram showing the call transfer operation made for a secondary user of extension number 200 as the second embodiment.

As is shown in FIG. 14, given that a call which specifies extension number 200 as the number of a call receiving end is made by an external terminal TT2, and an incoming call signal including extension number 200 reaches the router RT from the public network NW accordingly ((1) of FIG. 14), the router RT transfers the incoming call signal to the call control server SV via the IP network 1 ((2) of FIG. 14).

The call control server SV extracts the incoming call number from the incoming call signal notified by the router RT, and determines the call receiving end corresponding to the incoming call number 200 based on the registration data management table 272.

Here, when the extension number 200 that is the primary number of IP telephone terminal T11 is used at the IP telephone terminal T21, the call control server SV makes an incoming call notification by transmitting the incoming call signal to IP telephone terminal T21 ((3) of FIG. 14).

However, if IP telephone terminal T21 does not respond within predetermined time, the call control server SV determines a user who is now logging in for extension number 200 as the secondary user of IP telephone terminal T21 based on the registration data management table 272. Further, the call control server SV refers to the function setting table 273 corresponding to extension number 300, which is the primary number of IP telephone terminal T21, and determines whether a call transfer function is set. Here, since the call transfer function is not set, the call control server SV continues the call for IP telephone terminal T21, and when a disconnecting operation is performed by the external terminal TT2 ((4) of FIG. 14), the call for IP telephone terminal T21 is terminated ((5) of FIG. 14).

As stated above, as in the first embodiment previously described, the system of the second embodiment can also restrict the communication service to be used depending on the user of each of IP telephone terminals T11 and T21 when a single extension number 200 is shared.

### Other Embodiments

In each of the above embodiments, reference was made to the case where an extension number is shared among a plurality of IP telephone terminals. However, identification information, such as the user ID, may be shared among the plurality of IP telephone terminals.

In the first embodiment, reference was made to the SIP by way of example. The SIP may be replaced with MEGACO, if so desired.

Further, in the first embodiment, reference was made to the case where emergency call service was realized by using a shared extension number, and in the second embodiment, reference was made to the case where call transfer service was realized. However, the system may be altered such that a primary user of extension number 200 can perform video communication and a secondary user of extension number 200 can perform only voice communication.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A telephone system comprising:
a plurality of telephone terminals configured to which IP addresses are assigned; and
a server apparatus configured to register the plurality of telephone terminals, wherein
the server apparatus comprises:
a memory configured to store in an authentication management table associating identification information with first authentication information and second authentication information, wherein the identification information is information to use a plurality of communication services relating to exchange processing among the plurality of telephone terminals, wherein the first authentication information allows use of the plurality of communication services, and wherein the second authentication information is subsidiary to the first authentication information and allows use of at least a part of the plurality of communication services;
a determination module configured to refer to the authentication management table based on the identification information and the authentication information included in a registration request, and determine whether registration is authenticated based on the reference result, when the registration request including the identification information and authentication information is received from one of the telephone terminals;
a storage controller configured to associate the identification information with attribute information indicating the first authentication information/second authentication information used in the authentication, and the IP addresses, and store the identification information, the attribute information, and the IP addresses in a registration management table based on the determination result by the determination module; and
a service controller configured to perform control regarding use of the communication services by the telephone terminals registered based on the registration management table.

2. The telephone system of claim 1, further comprising a terminal position memory configured to store a position management table the IP addresses in association with position information indicating positions of the telephone terminals, wherein
when an emergency call is made by a telephone terminal registered in the registration management table by using the second authentication information, the service controller reads the position information regarding the telephone terminal from the position management table, and transmits an emergency call request including the position information to a call receiving end.

3. The telephone system of claim 1, wherein when an IP address of a first telephone terminal to be primarily used is already stored in association with the identification information in the registration management table, the storage controller rejects storing a second telephone terminal which requested registration on the same identification information in the registration management table.

4. The telephone system of claim 1, wherein the memory stores an authentication management table associating an extension number with the identification information and the first authentication information and the second authentication information.

5. The telephone system of claim 1, wherein the determination module determines whether a hash value calculated by using the authentication information included in the registration request agrees with a hash value calculated by using the corresponding identification information in the authentication management table.

6. A server apparatus registering a plurality of telephone terminals, IP addresses being assigned to the plurality of telephone terminals, the server apparatus comprising:
a memory configured to store an authentication management table associating identification information with first authentication information and second authentication information, wherein the identification information is information to use a plurality of communication services relating to exchange processing among the plurality of telephone terminals, wherein the first authentication information allows use of the plurality of communication services, and wherein the second authentication information is subsidiary to the first authentication information and allows use of at least a part of the plurality of communication services;
a determination module configured to refer to the authentication management table based on the identification information and the authentication information included in a registration request, and determine whether registration is authenticated based on the reference result, when the registration request including the identification information and authentication information is received from one of the telephone terminals;
a storage controller configured to associate the identification information with attribute information indicating the first authentication information/second authentication information used in the authentication, and the IP addresses, and store the identification information, the attribute information, and the IP addresses in a registration management table based on the determination result by the determination module; and
a service controller configured to perform control regarding use of the communication services by the telephone terminals registered based on the registration management table.

7. The server apparatus of claim 6, further comprising a terminal position memory configured to store a position management table associating the IP addresses with position information indicating positions of the telephone terminals, wherein
when an emergency call is made by a telephone terminal registered in the registration management table by using the second authentication information, the service controller reads the position information regarding the telephone terminal from the position management table, and transmits an emergency call request including the position information to a call receiving end.

8. The server apparatus of claim 6, wherein when an IP address of a first telephone terminal to be primarily used is already stored in association with the identification information in the registration management table, the storage controller rejects storing a second telephone terminal which requested registration on the same identification information in the registration management table.

9. The server apparatus of claim 6, wherein the memory stores an authentication management table associating an extension number with the identification information, and the first authentication information and the second authentication information.

10. The server apparatus of claim 6, wherein the determination module determines whether a hash value calculated by using the authentication information included in the registration request agrees with a hash value calculated by using the corresponding identification information in the authentication management table.

11. A control method used in a server apparatus registering a plurality of telephone terminals, IP addresses being assigned to the plurality of telephone terminals, the control method comprising:
storing an authentication management table associating identification information with first authentication information and second authentication information in a memory, wherein the identification information is information to use a plurality of communication services relating to exchange processing among the plurality of telephone terminals, wherein the first authentication information allows use of the plurality of communication services, and wherein the second authentication information is subsidiary to the first authentication information and allows use of at least a part of the plurality of communication services;
referring, when a registration request including the identification information and authentication information is received from one of the telephone terminals, to the authentication management table based on the identification information and the authentication information included in the registration request, and determining whether registration is authenticated based on the reference result;
performing storage control by associating the identification information with attribute information indicating the first authentication information/second authentication information used in the authentication, and the IP addresses, and storing the identification information, the attribute information, and the IP addresses in a registration management table based on the determination result; and
performing service control regarding use of the communication services by the telephone terminals registered based on the registration management table.

12. The control method of claim 11, further comprising storing a position management table associating IP addresses with position information indicating positions of the telephone terminals in a terminal position memory, wherein
when an emergency call is made by a telephone terminal registered in the registration management table by using the second authentication information, the performing service control comprises reading the position information regarding the telephone terminal from the position management table, and transmitting an emergency call request including the position information to a call receiving end.

13. The control method of claim 11, wherein when an IP address of a first telephone terminal to be primarily used is already stored in association with the identification information in the registration management table, the performing storage control comprises rejecting storage of a second telephone terminal which requested registration on the same identification information in the registration management table.

14. The control method of claim 11, wherein the storing comprises storing an authentication management table in which an extension number, which is the identification information, is associated with the first authentication information and the second authentication information.

15. The control method of claim 11, wherein the determining comprises determining whether a hash value calculated by using the authentication information included in the registration request agrees with a hash value calculated by using the corresponding identification information in the authentication management table.
